(19) United States
(12) Patent Application Publication
(10) Pub. No.: US 2007/0092201 A1
(43) Pub. Date: Apr. 26, 2007

(54) Reproducing device having repetitive reproduction function and repetitive reproduction function control program

(75) Inventor: Tomo Kawahara, Echizen-city (JP)

Correspondence Address: WESTERMAN, HATTORI, DANIELS & ADRIAN, LLP, 1250 CONNECTICUT AVENUE, NW, SUITE 700, WASHINGTON, DC, 20036, US

(73) Assignee: ORION ELECTRIC CO., LTD., Echizen-city (JP)

(21) Appl. No.: 11/582,479

(22) Filed: Oct. 18, 2006

(30) Foreign Application Priority Data
Oct. 20, 2005 (JP) 2005-306294

(51) Int. Cl. H04N 5/91

(52) U.S. Cl. 386/68

(57) ABSTRACT

A reproducing device for reproducing contents recorded on an information recording medium has a repetitive reproduction function to reproduce contents in a predetermined repeating range repeatedly in diverse reproduction modes. A special reproduction mode request requesting a special reproduction mode, such as a slow-motion reproduction mode, is accepted during a repetitive reproduction process for repetitively reproducing the repeating range. When the special reproduction mode request is made the repetitive reproduction process is continued in a reproduction mode specified by the special reproduction mode request.

The present application is based on and claims priority of Japanese patent application No. 2005-306294 filed on Oct. 20, 2005, the entire contents of which are hereby incorporated by reference.

### BACKGROUND OF THE INVENTION

1. Field of the Invention

The present invention relates to a reproducing device for reproducing contents including images and sounds recorded on an information recording medium. More particularly, the present invention relates to a reproducing device having a repetitive reproduction function to reproduce contents in a predetermined range repetitively.

2. Description of the Related Art

A known reproducing device, such as a DVD player, for reproducing contents including images and sounds recorded on an information recording medium, such as a DVD, has a repetitive reproduction function to reproduce contents in a predetermined range repetitively. Techniques relating with such repetitive reproduction function are disclosed in JP-Y 3096532 (Patent document 1), JP-A 2004-40705 (Patent document 2) and JP-A 2004-48611 (Patent document 3).

Basically, the repetitive reproduction function of a known reproducing device simply reproduces contents in a repeating range repetitively and cannot reproducing contents in various reproduction modes, such as special reproduction modes including a slow-motion reproduction mode.

### SUMMARY OF THE INVENTION

The present invention has been made in view of the foregoing circumstances and it is therefore an object of the present invention to provide a reproducing device, for reproducing contents recorded on an information recording medium, having a repetitive reproduction function to reproduce contents in a predetermined repeating range repetitively by any one of diverse reproducing procedures.

In a first aspect, a reproducing device having a repetitive reproduction function according to the present invention capable of repetitively reproducing a reproducing range and of carrying out a reproducing procedure for reproducing a single or a plurality of sets of contents recorded on an information recording medium includes: a storage device storing a repeating range defined by a repetition start point and a repetition end point; a reproducing unit; and a control unit. When a special reproduction mode request is made during the execution of the repetitive reproduction function, the reproducing procedure is executed in special reproduction modes requested by the special reproduction mode request while the reproducing procedure for repetitively reproducing contents in the repeating range is continued.

Thus the special reproduction mode request is accepted even during the execution of the repetitive reproduction function. The term “special reproduction mode” signifies a reproduction mode different from a normal reproduction mode, such as a slow-motion reproduction mode, a reverse slow-motion reproduction mode, a quick forward reproduction mode, a quick reverse reproduction mode or a reverse reproduction mode.

In a second aspect, a reproducing device having a repetitive reproduction function according to the present invention capable of repetitively reproducing contents in a repeating range and of carrying out a reproducing procedure for reproducing a single or a plurality of sets of contents recorded on an information recording medium includes: a storage device storing a repeating range defined by a repetition start point and a repetition end point; a reproducing unit; and a control unit. The storage device stores a repetitive reproduction mode setting table containing, in combination, predetermined reproduction modes in which reproducing procedures are to be carried out during the execution of the repetitive reproduction function and information about the number of repetitions. Reproducing procedures are executed in the predetermined reproduction modes contained in the repetitive reproduction mode setting table by a number of reproducing cycles corresponding to the number of repetitions during the execution of the repetitive reproduction function.

Thus the reproducing procedures are changed according to the number of repetitions in conformity with information contained in the repetitive reproduction mode setting table during the execution of the repetitive reproduction function, i.e., during the execution of a repetitive reproduction process. For example, a normal reproducing procedure, a slow-motion reproducing procedure, a normal reproducing procedure, a slow-motion reproducing procedure and such can be sequentially executed.

In a third aspect, a reproducing device having a repetitive reproduction function according to the present invention capable of repetitively reproducing contents in a repeating range and of carrying out a reproducing procedure for reproducing a single or a plurality of sets of contents recorded on an information recording medium includes: a storage device storing a repeating range defined by a repetition start point and a repetition end point; a reproducing unit; and a control unit. A plurality of repeating ranges are stored in the storage device, a repetitive reproduction process for repeating a reproducing cycle for sequentially reproducing the plurality of repeating ranges is executed, an individual repetitive reproduction mode setting table containing, in combination, the plurality of repeating ranges and reproduction modes is stored in the storage device, and a reproducing process conforming to the individual repetitive reproduction mode setting table is executed for the repeating range to be reproduced during the execution of the repetitive reproduction function.

The reproducing procedure is changed for each reproducing range in conformity with information contained in the individual repetitive reproduction mode setting table during the execution of the repetitive reproduction function. For example, a repetitive reproduction process including a repeating range 1 for a normal reproducing procedure, a repeating range 2 for a slow-motion reproducing procedure, the repeating range 1 for a normal reproducing procedure, the repeating range 2 for a slow-motion reproducing procedure and such can be executed.

In a fourth aspect, a repetitive reproduction function control program according to the present invention to be executed by a reproducing device having a repetitive reproduction function, capable of repetitively reproducing one set or a plurality of sets of contents recorded in an information recording medium, and including a storage device storing a repeating range defined by a repetition start point and a repetition end point, a reproducing unit, and a control unit, wherein the storage device stores a repetitive reproduction mode setting table containing, in combination, predetermined repetitive reproduction modes to be carried out during the execution of the repetitive reproduction function and information about the number of repetitions. The repetitive reproduction function control program includes the steps of: obtaining a reproduction modes combined with the information about the number of repetitions from the repetitive reproduction mode setting table when a request for execution of the repetitive reproduction function is made; and reproducing the repeating range by the number of repetitions for the execution of the repetitive reproduction function in the reproduction mode obtained from the repetitive reproduction mode setting table.

In a fifth aspect, a repetitive reproduction function control program according to the present invention to be executed by a reproducing device having a repetitive reproduction function, capable of repetitively reproducing one set or a plurality of sets of contents recorded in an information recording medium, and including a storage device storing repeating ranges each defined by a repetition start point and a repetition end point and an individual repetitive reproduction mode setting table containing, in combination, the plurality of repeating ranges and reproduction modes, a reproducing unit and a control unit includes the steps of: obtaining a reproduction mode combined with the repeating range from the individual repetitive reproduction mode setting table when a request for execution of the repetitive reproduction function is made; and repeating a process for sequentially repeating the repeating ranges in the reproduction modes obtained from the individual repetitive reproduction mode setting table.

The reproducing device of the first aspect having a repetitive reproduction function capable of repetitively reproducing a reproducing range and of carrying out a reproducing procedure for reproducing a single or a plurality of sets of contents recorded on an information recording medium includes: a storage device storing a repeating range defined by a repetition start point and a repetition end point; a reproducing unit; and a control unit; wherein, when a special reproduction mode request is made during the execution of the repetitive reproduction function, the reproducing procedure is executed in special reproduction modes specified by the special reproduction mode request while the reproducing procedure for repetitively reproducing contents in the repeating range is continued. Thus the special reproduction mode request is accepted even during the execution of the repetitive reproduction function. Therefore, diverse reproducing procedures including a slow-motion reproducing procedure can be carried out during the execution of the repetitive reproduction function and the operability of the reducing device is excellent.

The reproducing device of the second aspect having a repetitive reproduction function capable of repetitively reproducing contents in a repeating range and of carrying out a reproducing procedure for reproducing a single or a plurality of sets of contents recorded on an information recording medium includes: a storage device storing a repeating range defined by a repetition start point and a repetition end point; a reproducing unit; and a control unit. The storage device stores a repetitive reproduction mode setting table containing, in combination, predetermined reproduction modes in which reproducing procedures are to be carried out during the execution of the repetitive reproduction function and information about the number of repetitions. Reproducing procedures are executed in the predetermined reproduction modes contained in the repetitive reproduction mode setting table by a number of reproducing cycles corresponding to the number of repetitions during the execution of the repetitive reproduction function. Thus the reproducing procedures are changed according to the number of repetitions during the execution of the repetitive reproduction function, i.e., during the execution of a repetitive reproduction process. For example, a scene of close play in a sports game can be reproduced through the sequential execution of a normal reproducing procedure, a reverse slow-motion reproducing procedure, a normal reproducing procedure, and a reverse slow-motion reproducing procedure or of a normal reproducing procedure, a slow-motion reproducing procedure, a reverse slow-motion reproducing procedure, and a normal reproducing procedure and such. Thus the operability of the reproducing device is excellent.

The reproducing device of the third aspect having a repetitive reproduction function capable of repetitively reproducing contents in a repeating range and of carrying out a reproducing procedure for reproducing a single or a plurality of sets of contents recorded on an information recording medium includes: a storage device storing a repeating range defined by a repetition start point and a repetition end point; a reproducing unit; and a control unit; wherein a plurality of repeating ranges are stored in the storage device, a repetitive reproduction process for repeating a reproducing cycle for sequentially reproducing the plurality of repeating ranges is executed, an individual repetitive reproduction mode setting table containing, in combination, the plurality of repeating ranges and reproduction modes is stored in the storage device, and a reproducing process conforming to the individual repetitive reproduction mode setting table is executed for the repeating range to be reproduced during the execution of the repetitive reproduction function. The reproducing procedures are changed according to each reproducing range in conformity with information contained in the individual repetitive reproduction mode setting table during the execution of the repetitive reproduction function. For example, when two repeating ranges 1 and 2 are set, a repetitive reproduction process including normal reproduction mode reproducing procedure for the repeating range 1, a slow-motion reproduction mode reproducing procedure for the repeating range 2 and such can be executed. Consequently, reproducing procedures can be diversified and the operability of the reproducing device is excellent.

### BRIEF DESCRIPTION OF THE DRAWINGS

The above and other objects, features and advantages of the present invention will become more apparent from the following description taken in connection with the accompanying drawings, in which:

FIG. 1 is a block diagram of an essential part of a DVD reproducing device in a first embodiment according to the present invention;

FIG. 2 is a flowchart of a procedure according to the present invention to be carried out by the DVD reproducing device;

FIG. 3 is a flowchart of a repetitive reproduction process;

FIG. 4 is a schematic plan view of a remote controller;

FIG. 5 is a block diagram of a part relevant to the present invention of a DVD reproducing device provided with a liquid crystal display (LCD);

FIG. 6 is a perspective view of the LCD incorporated into the DVD reproducing device;

FIG. 7 is a flowchart of a procedure for starting and ending a repetitive reproduction process in a second embodiment according to the present invention;

FIG. 8 is a flowchart of the repetitive reproduction process in the second embodiment;

FIG. 9 is a picture of an example of a repetitive reproduction process setting window displayed on a screen;

FIG. 10 is an example of a repetitive reproduction mode setting table;

FIG. 11 is a flowchart of a procedure for starting and ending a repetitive reproduction process in a third embodiment according to the present invention;

FIG. 12 is a flowchart of the repetitive reproduction process to be executed by the third;

FIG. 13 is a repetitive reproduction mode setting table;

FIG. 14 is an example of a window for setting the repetitive reproduction process to be executed by the third embodiment; and

FIG. 15 is another repetitive reproduction mode setting table.

### DESCRIPTION OF THE PREFERRED EMBODIMENTS

Preferred embodiments of the present invention will be described with reference to the accompanying drawings. The preferred embodiments specifically described herein are only examples and is not intended to limit the scope of the present invention.

### FIRST EMBODIMENT

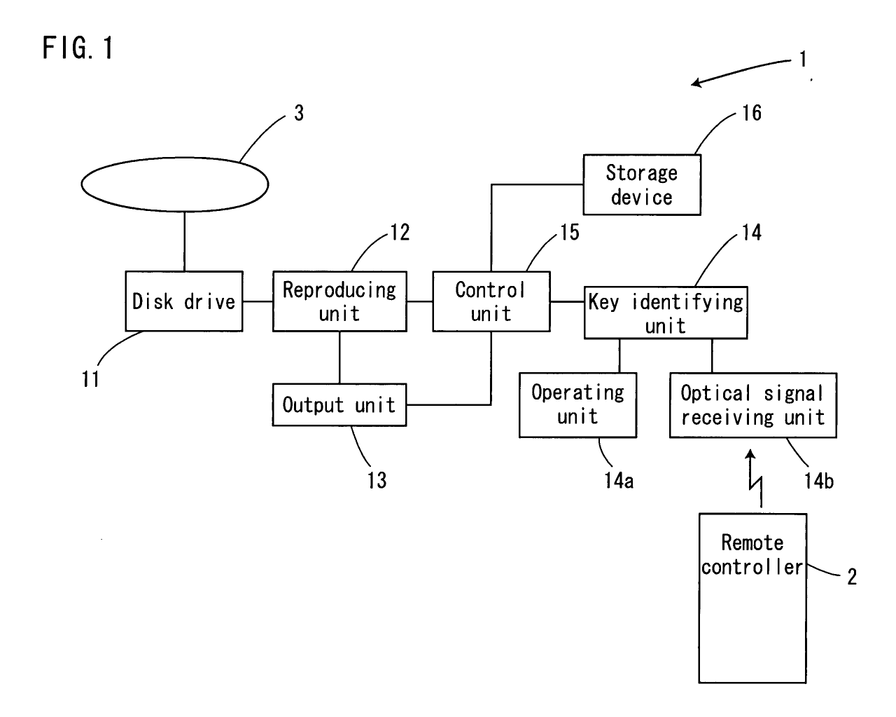

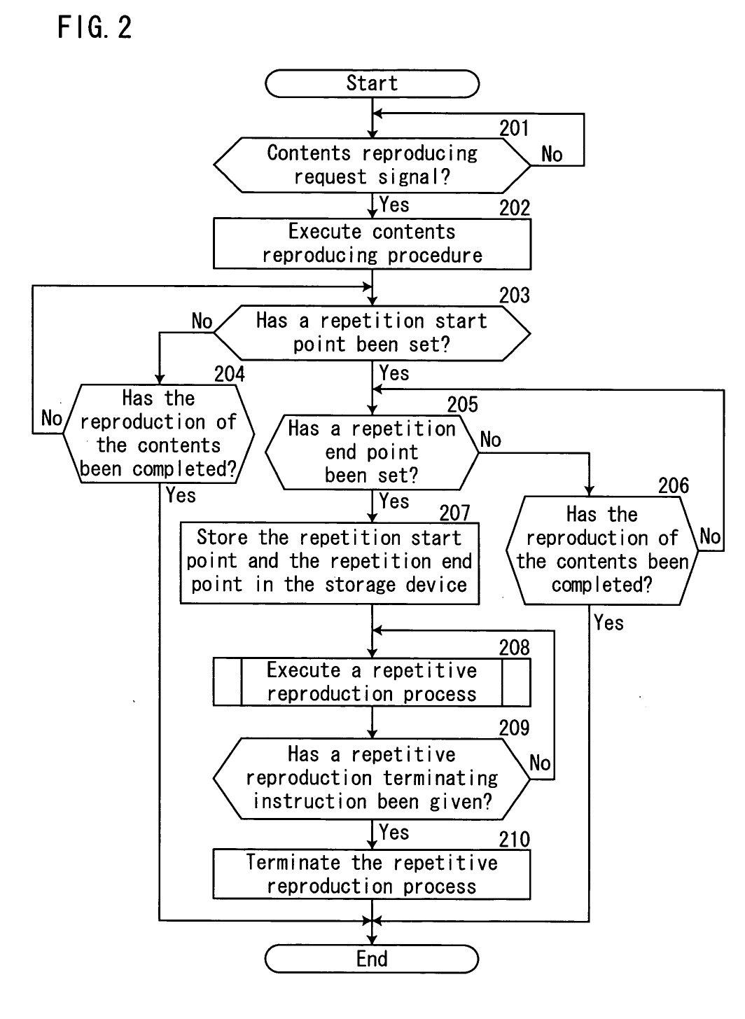

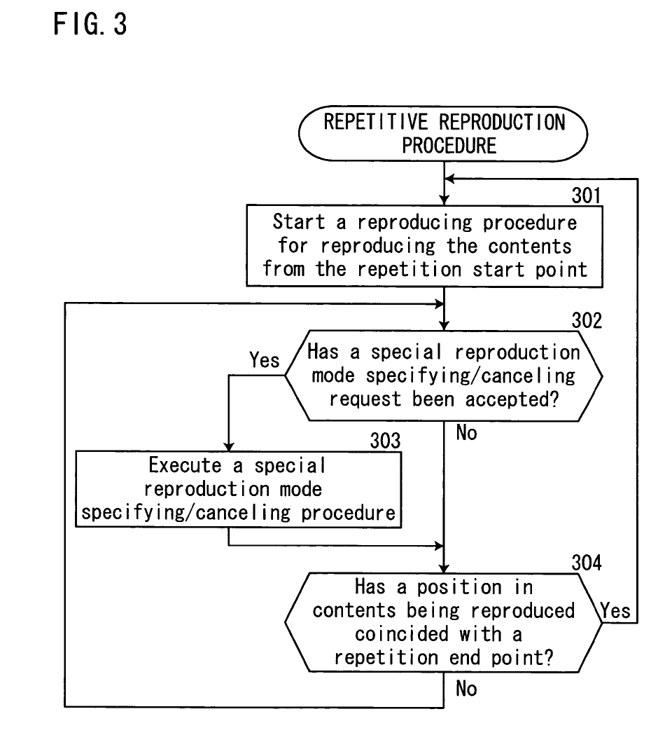

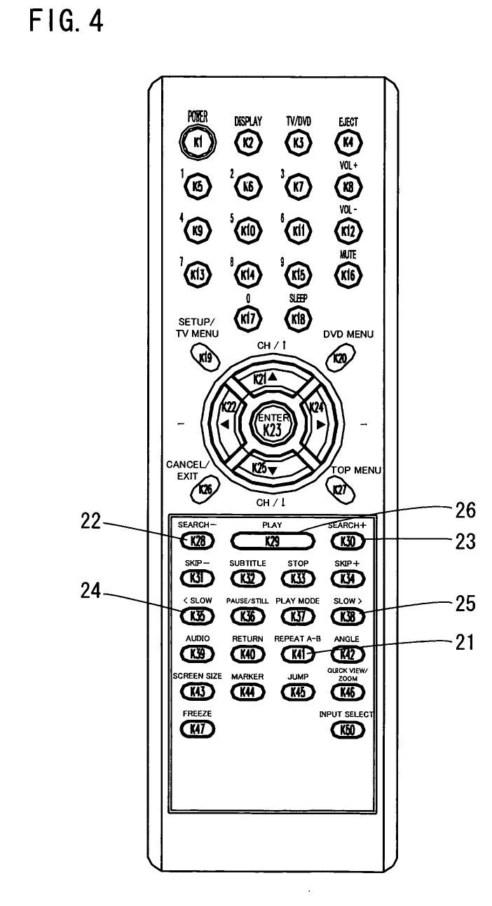

FIG. 1 is a block diagram of an essential part of a DVD reproducing device 1 in a first embodiment according to the present invention, FIGS. 2 and 3 are flowcharts of procedures to be carried out by the DVD reproducing device 1 and FIG. 4 is a schematic plan view of a remote controller 2.

Referring to FIG. 1, the DVD reproducing device 1 includes a disk drive 11 for reading information from a DVD 3, namely, an information recording medium, a reproducing unit 12 provided with a decoder or the like for expanding data provided by the disk drive 11 and capable of carrying out a reproducing process for reproducing the contents of the DVD 3, an output unit 13 for sending video/sound signals generated by the reproducing unit 12 to an external display, such as a television set, a key identifying unit 14 for identifying a signal provided by an operating unit 14a, namely, an input interface operated by a user, or an optical signal receiving unit 14b that receives signals provided by the remote controller 2 and provides an identification signal, a controller 15 for generally controlling operations of the DVD reproducing device 1, and a storage device 16, namely, a storage means. The DVD reproducing device 1 has a function to make the reproducing unit 12 and the control unit 15 execute a reproducing procedure in a special reproduction mode, such as a slow-motion reproduction mode, a reverse slow-motion reproduction mode, a quick forward reproduction mode, a quick reverse reproduction mode or a reverse reproduction mode, requested by a special reproduction mode request signal provided by the user.

Operations of the DVD reproducing device 1 will be described with reference to FIGS. 2 and 3. FIG. 2 is a flowchart of a procedure for setting, executing and ending a repetitive reproduction function.

The user operates the operating unit 14a or the remote controller 2, namely, an input device, to enter a contents reproducing request signal in step 201. Then, the disk drive 11, the reproducing unit 12 and the controller 15 operate to carry out a contents reproducing procedure for reproducing the contents of the DVD 3 in step 202. A query is made in step 203 to see whether or not a repetition function key 21 is operated to enter a repetition start point setting request signal. If the repetition function key 21 has not been operated or the reproduction of the contents has been completed (step 204), the procedure is ended. If the repetition function key 21 is operated, a point where the repetition function key 21 is operated is stored temporarily as a repetition start point in the storage device 16 and a query is made in step 205 to see whether or not the repetition function key 21 is operated again to enter a repetition end point setting request signal. If the repetition end function key 21 has not been operated or the reproduction of the contents has been completed (step 206), the procedure is ended. If the repetition function key 21 is operated again to enter repetition end point setting request signal, a point where the repetition function key 21 is operated again is set as a repetition end point and the procedure goes to step 207.

In step 207, the repetition start point determined in step 203 and the repetition end point determined in step 205 are stored in the storage device 16. In step 208, a repetitive reproduction process shown in FIG. 3 is carried out. A query is made in step 209 to see whether or not a repetitive reproduction terminating instruction is given. If the response to the query in step 209 is affirmative, the repetitive reproduction process is terminated in step 210 and the procedure is ended. The repetitive reproduction terminating instruction is an instruction requiring the termination of only the repetitive reproduction process without stopping a contents reproducing operation provided by operating the repetition function key 21 again or by operating a stop button to enter a contents reproduction stop instruction or a disconnection instruction provided by operating a main switch to disconnect the DVD reproducing device 1 from a power supply.

Referring to FIG. 3 showing a flowchart of the repetitive reproduction process, a reproducing procedure for reproducing the contents is started from the repetition start point in step 301. The controller 15 reads the repetition start point from the storage device 16. The reproducing unit 12 controls the disk drive 11 on the basis of information about the repetition start point, reads data on the contents from the repetition start point and generates a video/sound signal from the data. The output unit 13 sends out the video/sound signal generated by the reproducing unit 12.

In step 302, a special reproduction mode specifying/canceling request requesting specifying or canceling a special reproduction mode, such as a slow-motion reproduction mode, is accepted. If the special reproduction mode specifying/canceling request is made, a special reproduction mode, such as a slow-motion reproduction mode, is executed or a special reproduction mode is cancelled and the reproducing procedure is executed in the normal reproduction mode in step 303. The special reproduction mode specifying/canceling request is made by operating the operating unit 14a or by operating one of the keys 22 to 26 of the remote controller 2. The key identifying unit 14 and the control unit 15 identify the contents of the request. The reproducing unit 12 and the control unit 15 execute the reproducing procedure in a special reproduction mode specified by the request, such as a slow-motion reproduction mode.

When the reproducing unit 12 and the control unit 15 decide that a position in contents being reproduced has coincided with a repetition end point stored in the storage device 16 in step 304, the repetitive reproduction process returns to step 301 to repeat reproducing contents in a repeating range between the repetition start point and the repetition end point.

The DVD reproducing device 1 in the first embodiment accepts a special reproduction mode request even during the execution of the repetitive reproduction function. Therefore, diverse reproducing procedures including a slow-motion reproducing procedure can be executed during the execution of the repetitive reproduction function. For example, during the execution of a reproducing operation for reproducing a repeating range including a scene of a golf club swing motion, the reproducing procedure can be executed in special reproduction modes, such as a slow-motion reproduction mode and a reverse slow-motion reproduction mode. Thus the operability of the DVD reproducing device 1 is excellent.

The repeating range setting method shown in FIG. 2 defines a repeating range by a repetition start point and a repetition end point. Repeating ranges may be content units, such as a title and a chapter. Therefore, the term, “repeating range having a repetition start point and a repetition end point” does not literally signify only “repeating range defined by a repetition start point and a repetition end point” and may signify such information as a title or the like.

### SECOND EMBODIMENT

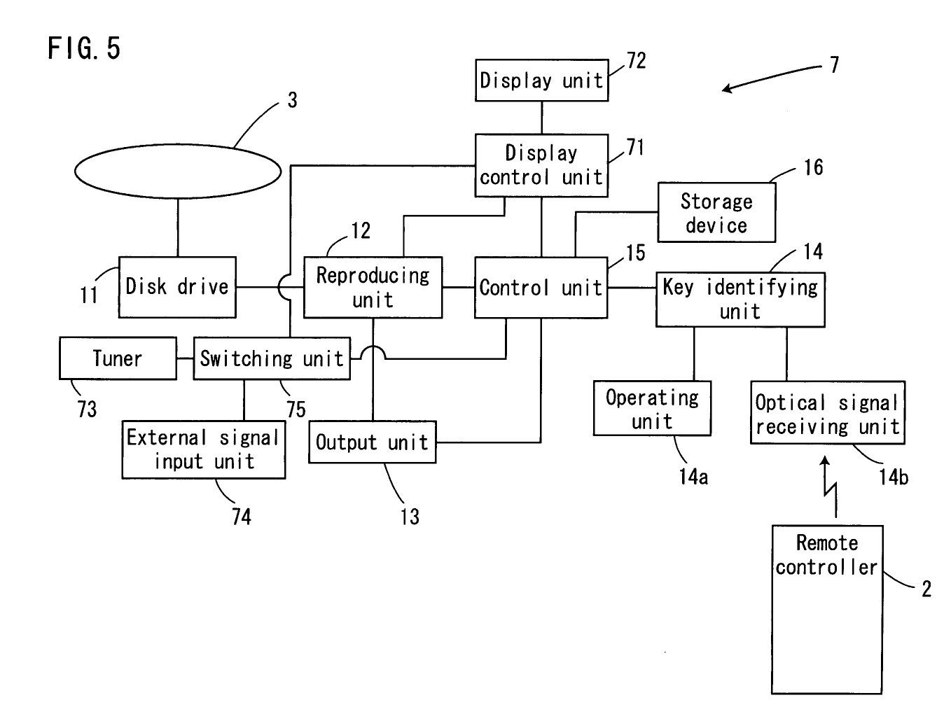

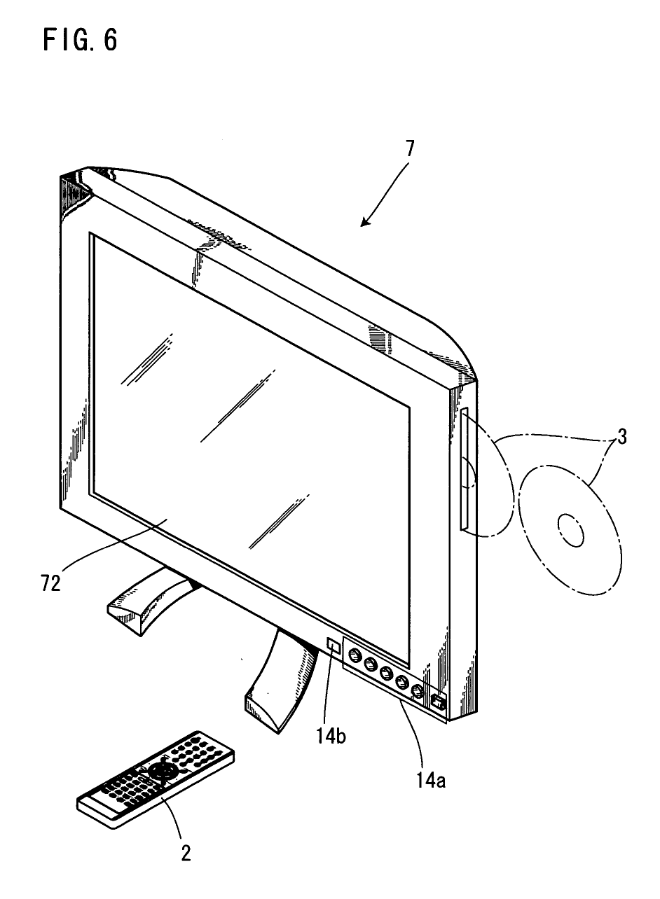

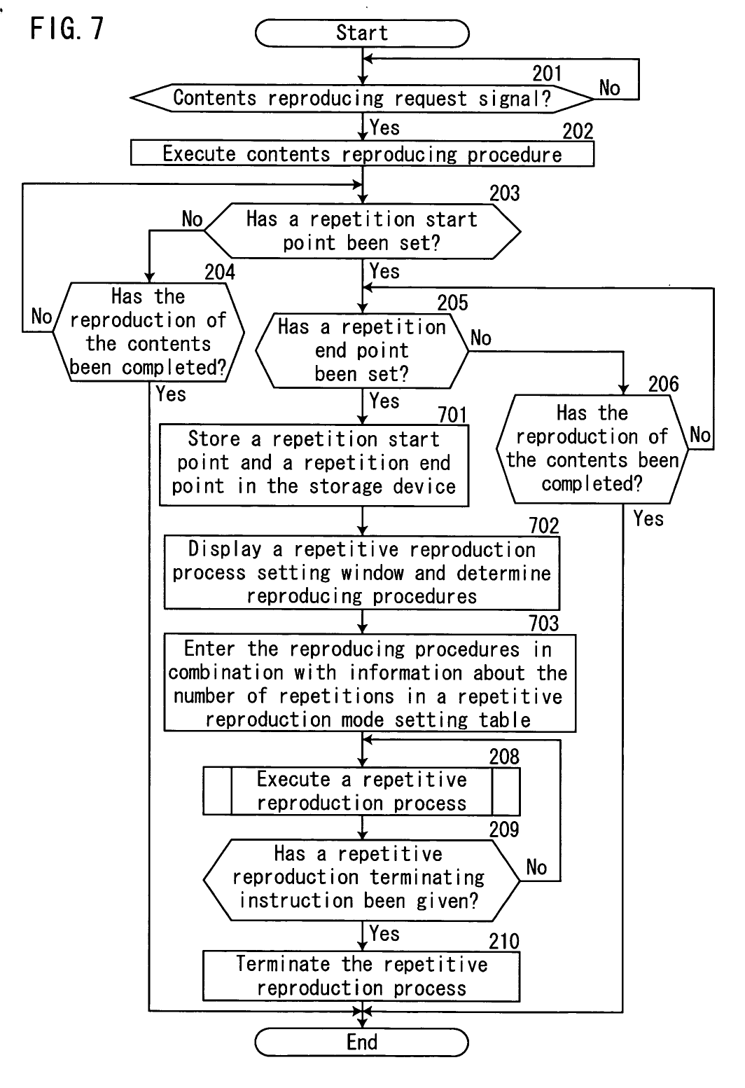

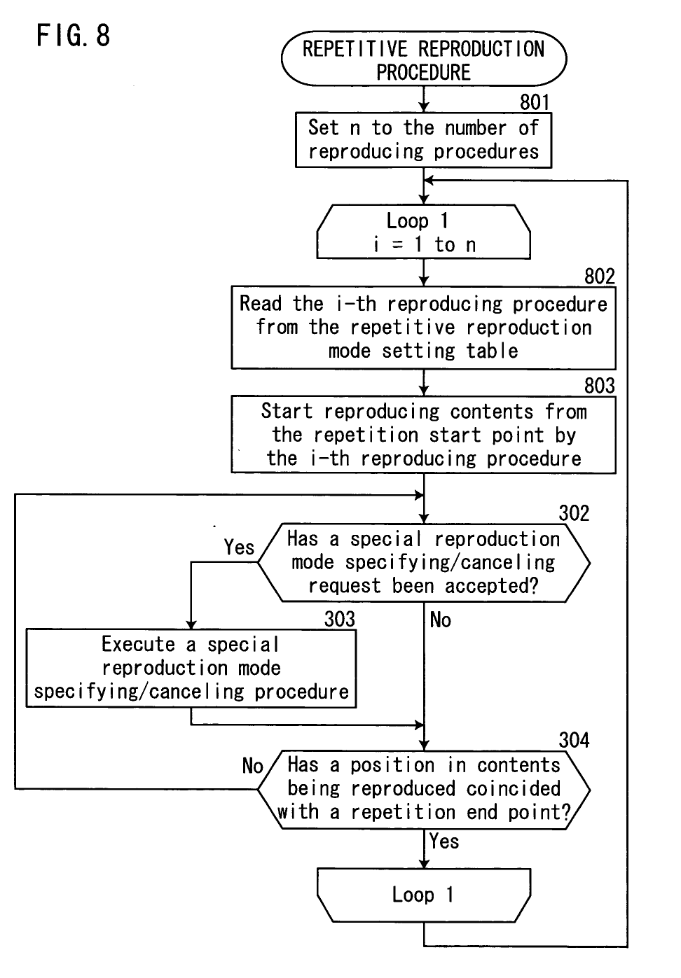

FIG. 5 is a block diagram of a part relevant to the present invention of a DVD reproducing device 7 in a second embodiment according to the present invention combined with a LCD (hereinafter, referred to simply as “DVD reproducing device 7”), in which parts like or corresponding to those of the DVD reproducing device 1 in the first embodiment shown in FIG. 1 are designated by the same reference characters and the description thereof will be omitted or simplified. FIG. 6 is a perspective view of the LCD incorporated into the DVD reproducing device 7, and FIGS. 7 and 8 are flowcharts of operations of parts relevant to the present invention.

Referring to FIG. 5, the DVD reproducing device 7, similarly to the DVD reproducing device 1 in the first embodiment, includes in addition to a disk drive 11, a reproducing unit 12, an output unit 13, and operating unit 14a, an optical signal receiving unit 14b, a key identifying unit 14, a control unit 15 and a storage device 16, a display unit 72 a tuner 73 for receiving broadcast signals, an external signal input unit 74 for receiving video/sound signal from an external device, such as a HDD recorder, a switching unit 75 for selectively providing a signal provided by the tuner 73 or the external signal input unit 74, and a display control unit 71 for controlling the display unit 72 to display images represented by video signals provided by the switching unit 75 or the reproducing unit 12. The DVD reproducing device 7 has a function to make the reproducing unit 12 and the control unit 15 execute the reproducing procedure in a special reproduction mode, such as a slow-motion reproduction mode, a reverse slow-motion reproduction mode, a quick forward reproduction mode, a quick reverse reproduction mode or a reverse reproduction mode, according to a reproduction mode request made by the user.

Operations relevant to the present invention of the DVD reproducing device 7 will be described briefly with reference to FIGS. 7 and 8. Operations shown in FIGS. 7 and 8 conceptually similar to those of the first embodiment shown in FIGS. 2 and 3 are denoted by the same numerals and the description thereof will be omitted or simplified.

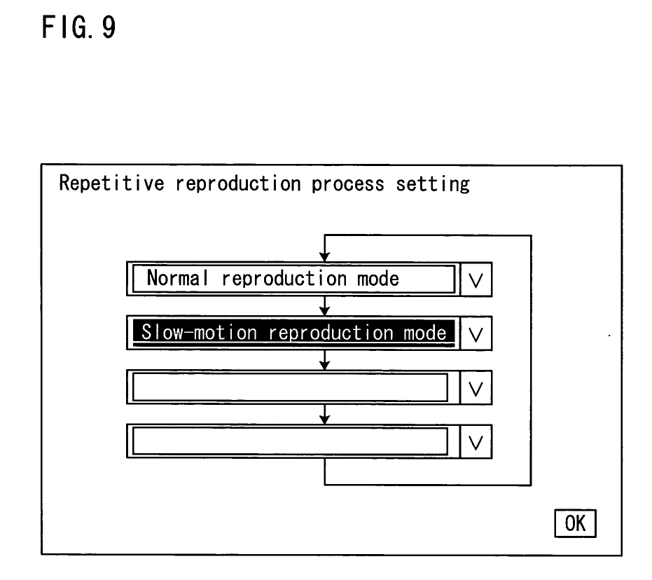

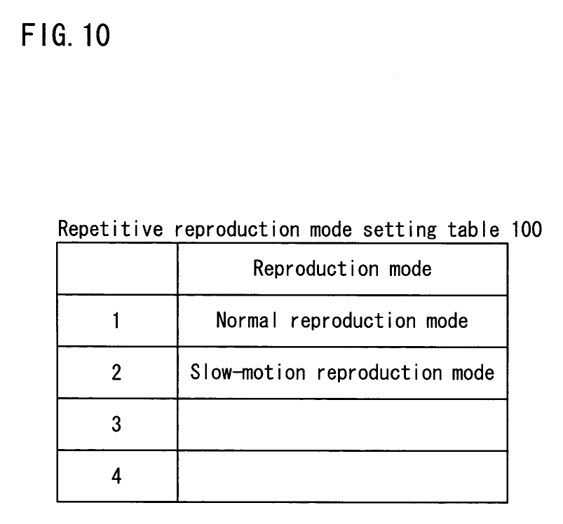

FIG. 7 is a flowchart of a procedure for setting executing and ending a repetitive reproduction function. The user sets a repeating range in steps 203 to 206. Then, in step 701, a repetition start point and a repetition end point set respectively in steps 203 and 205 are stored in the storage device 16. In step 702, a repetitive reproduction process setting window shown in FIG. 9 is displayed on the screen of the display unit 72. The control unit 15 having an OSD signal generating function and the display control unit 71 carry out a displaying process for displaying the repetitive reproduction process setting window. Reproducing procedures, such as a slow-motion reproducing procedure and a quick forward reproducing procedure, corresponding to the number of repetitions for the repeating range are determined. In step 703, the reproducing procedures are entered into a repetitive reproduction mode setting table 100 shown in FIG. 10 by way of example. The repetitive reproduction mode setting table 100 is stored in the storage device 16. Four reproducing procedures at a maximum corresponding to the number of repetitions can be set. Four reproducing procedures do not need necessarily to be set and only one reproducing procedure may be set. The DVD reproducing device may be designed so as to set more than four reproducing procedures. The user operates the remote controller 2 or the operating unit 14a following instructions displayed on the screen of the display unit. The key identifying unit 14 and the control unit 15 control the display unit to make the display unit display operations made by the user and obtain necessary information.

After the repetitive reproduction function has been thus set, a repetitive reproduction process shown in FIG. 8 is executed in step 208. The control unit 15 refers to the repetitive reproduction mode setting table 100 stored in the storage device 16 to find out the number of reproducing procedures (four reproducing procedures at a maximum) and sets a variable n to the number in step 801. Then a loop 1 of steps is repeated n times (i=n) . When the loop 1 is executed once, the n reproducing procedures (special reproducing procedures) contained in the repetitive reproduction mode setting table 100 are executed. The loop 1 is repeated until a repetitive reproduction end instruction is given in step 209 shown in FIG. 7. Thus reproducing procedure for reproducing the repeating range is repeated.

In step 802 included in the loop 1, the i-th reproducing procedure, such as a slow-motion reproducing procedure, is read from the repetitive reproduction mode setting table 100. In step 803, the i-th reproducing procedure is started to reproduce contents in the repeating range. Subsequently, steps 302 to 304, which are similar to steps 302 to 304 shown in FIG. 3 and executed by the DVD reproducing device 1 in the first embodiment, are executed. Upon the coincidence of a content reproducing position with the repetition end point, i is incremented by one and then the loop 1 is repeated, in which contents in the repeating range is reproduced by the next reproducing procedure contained in the repetitive reproduction mode setting table 100.

The DVD reproducing device 7 in the second embodiment can change the reproducing procedures according to the number of repetitions during the execution of the repetitive reproduction function, i.e., during the execution of a repetitive reproduction process. For example, a scene of close play in a sports game can be reproduced sequentially in a normal reproduction mode, a reverse slow-motion reproduction mode, a normal reproduction mode, and a reverse slow-motion reproduction mode or in a normal reproduction mode, a slow-motion reproduction mode, a reverse slow-motion reproduction mode, and a normal reproduction mode and such. Thus operability of the DVD reproducing device 7 is excellent.

The DVD reproducing device in the second embodiment requires specifying a reproduction mode every time a repeating range is set. Usually, the user is not required to specify a reproduction mode every time a repeating range is set and the normal reproduction mode is assigned automatically as a default to the repeating range to execute a reproducing procedure in the normal reproduction mode regardless of the number of repetitions during the execution of the repetitive reproduction function. When the user makes a reproduction mode setting request, a repetitive reproduction process setting window as shown in FIG. 9 may be displayed and this may be reflected in the repetitive reproduction mode setting table 100.

### THIRD EMBODIMENT

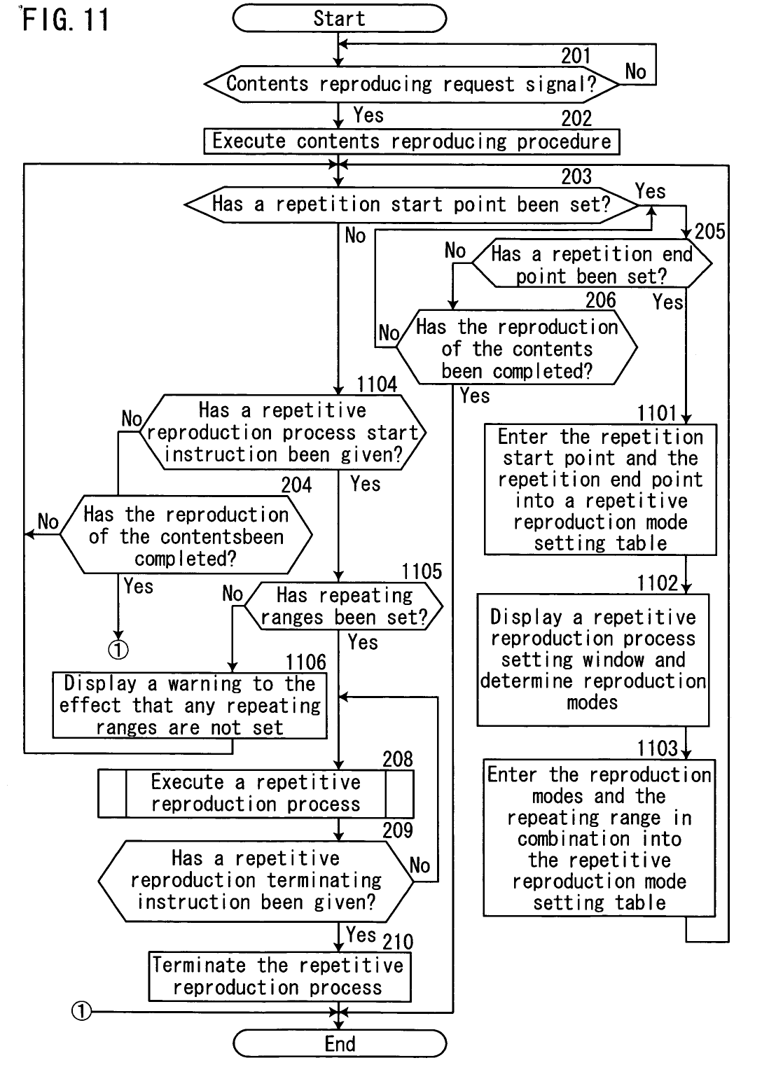

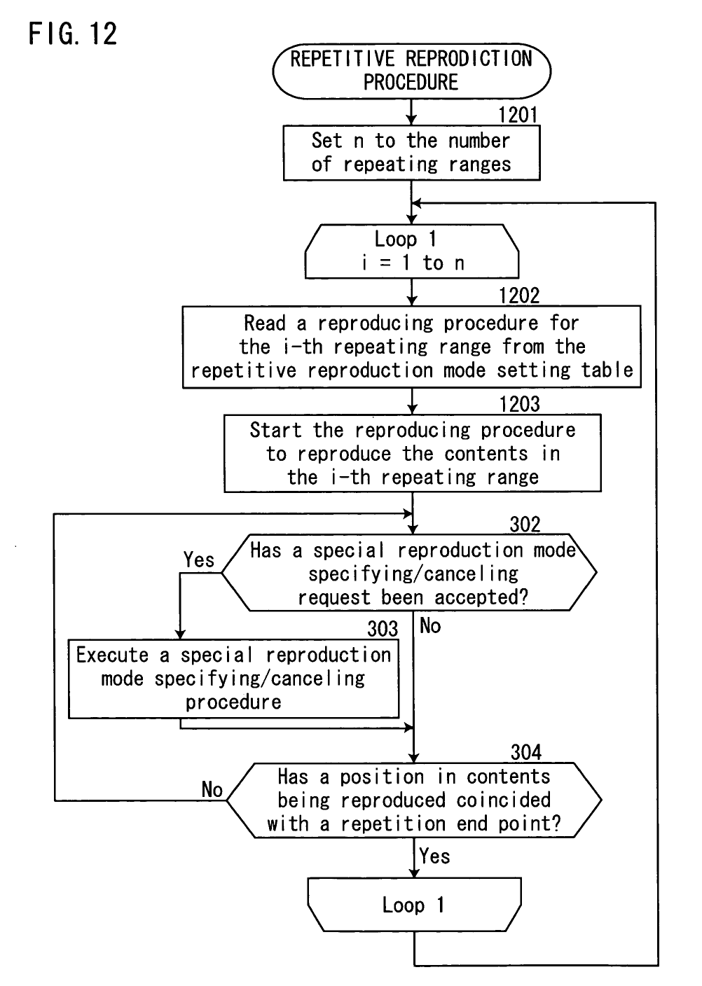

FIGS. 11 and 12 are flowcharts of operations, relevant to the present invention, of a DVD reproducing device in a third embodiment according to the present invention combined with a LCD. The DVD reproducing device in the third embodiment is similar to the DVD reproducing device 7 in the second embodiment and hence the description thereof will be omitted and reference to FIG. 5 will be made when necessary.

FIG. 11 is a flowchart of a procedure for setting executing and ending a repetitive reproduction function. Operations shown in FIG. 11 conceptually similar to those of the first embodiment shown in FIG. 2 are denoted by the same numerals and the description thereof will be omitted or simplified.

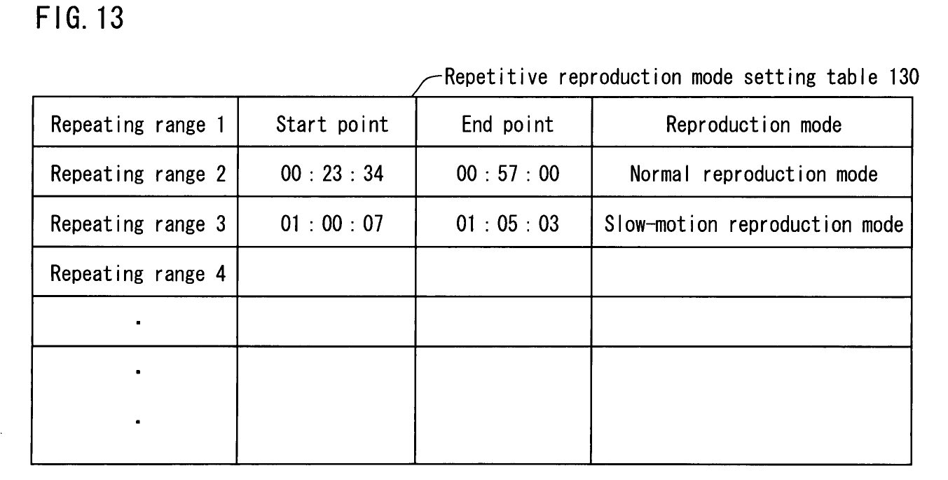

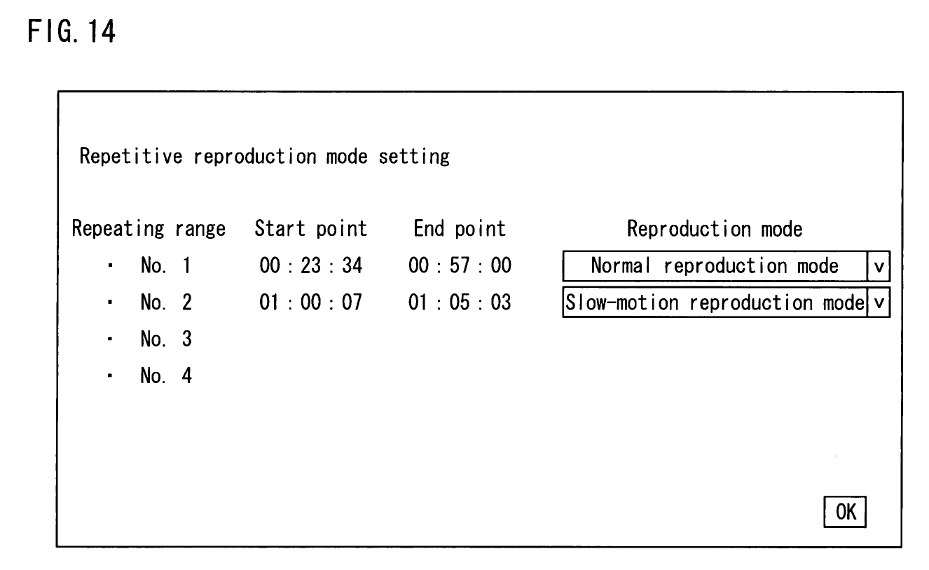

The user sets a repeating range in steps 203 to 206. In step 1101, a repetition start point and a repetition end point set respectively in steps 203 and 205 are entered into a repetitive reproduction mode setting table (individual repetitive reproduction mode setting table). The repetitive reproduction mode setting table is stored in the storage device 16. FIG. 13 shows a repetitive reproduction mode setting table by way of example. In step 1102, a repetitive reproduction process setting window as shown in FIG. 14 is displayed on the screen of the display unit 72. Reproduction modes, such as a slow-motion reproduction mode and a quick forward reproduction mode, are set for the set repeating ranges. The set reproduction modes and the repeating range are entered in combination into a repetitive reproduction mode setting table 130 and the repetitive reproduction mode setting table 130 is stored in the storage device 16 in step 1103. The DVD reproducing device in the third embodiment does not start a repetitive reproduction process immediately after a repeating range has been set. The repetitive reproduction process is started when the response to a query made in step 1104 to see whether or not the user has given a repetitive reproduction process start instruction is affirmative. A plurality of repeating ranges can be set before the repetitive reproduction process is started. When the repetitive reproduction start instruction is given, reference is made to the repetitive reproduction mode setting table 130 in step 1105 to see whether or not repeating ranges have been set. If any repeating ranges are not set, a warning is displayed to that effect on the screen of the display unit 72 in step 1106 and the procedure returns to step 203 and then step 203 and the following steps are repeated.

A repetitive reproduction process shown in FIG. 12 is executed in step 208 after the repetitive reproduction function has been thus set. Operations shown in FIG. 12 conceptually similar to those of the first embodiment shown in FIG. 3 are denoted by the same numerals and the description thereof will be omitted or simplified.

The repetitive reproduction process shown in FIG. 12 is started. Then, in step 1201, the control unit 15 refers to the repetitive reproduction mode setting table 130 stored in the storage device 16 for the number of repeating ranges and sets the variable n to the number. Then a loop 1 of steps is repeated n times (i=n). When the loop 1 is executed once, the n reproducing procedures (special reproducing procedures) are sequentially executed once. When two repeating ranges 1 and 2 are set as shown in FIG. 13, a reproducing procedure is executed in a normal reproduction mode for the region 1, and then a reproducing procedure is executed in a slow-motion reproduction mode for the second reproducing range. The loop 1 is repeated until a repetitive reproduction end instruction is give in step 209 shown in FIG. 11. Thus the reproducing procedures for reproducing the repeating ranges are repeated sequentially. In this example, the reproducing procedure in the normal reproduction mode (the repeating range 1), the reproducing procedure in the slow-motion reproduction mode (the repeating range 2), the reproducing procedure in the normal reproduction mode (the repeating range 1) . . . are repeated.

In step 1202 of the loop 1, a reproducing procedure, such as a slow-motion reproducing procedure, for the i-th repeating range is read from the repetitive reproduction mode setting table 130. In step 1203, the reproducing procedure for the i-th repeating range contained in the repetitive reproduction mode setting table 130 is started. Subsequently steps 302 and 303, which are similar to steps 302 and 303 shown in FIG. 3 and executed by DVD reproducing device 1 in the first embodiment, are executed. When it is decided that a content reproducing position has coincided with the repetition end point of the i-th repeating range in step 304, i is incremented by one and then the loop 1 is repeated, in which contents in the next repeating range is reproduced by the next reproducing procedure contained in the repetitive reproduction mode setting table 130.

The DVD reproducing device in the third embodiment provided with the LCD can execute reproducing procedures respectively in different reproduction modes for repeating ranges in the reproduction process. For example, when two repeating ranges 1 and 2 are set, a repetitive reproduction process including a normal mode reproducing procedure for the repeating range 1, a slow-motion reproduction procedure for the repeating range 2, a normal mode reproducing procedure for the repeating range 1, and a slow-motion reproduction procedure for the repeating range 2 and such can be executed. Consequently, reproducing procedures can be diversified and the operability of the reproducing device is excellent.

The DVD reproducing device in the third embodiment requires specifying a reproduction mode every time a repeating range is set. Usually, the user is not required to specify a reproduction mode every time a repeating range is set and the normal reproduction mode is assigned automatically as a default to the repeating range. When the user makes a reproduction mode setting request, a repetitive reproduction process setting window as shown in FIG. 14 may be displayed and this may be reflected in the repetitive reproduction mode setting table 130.

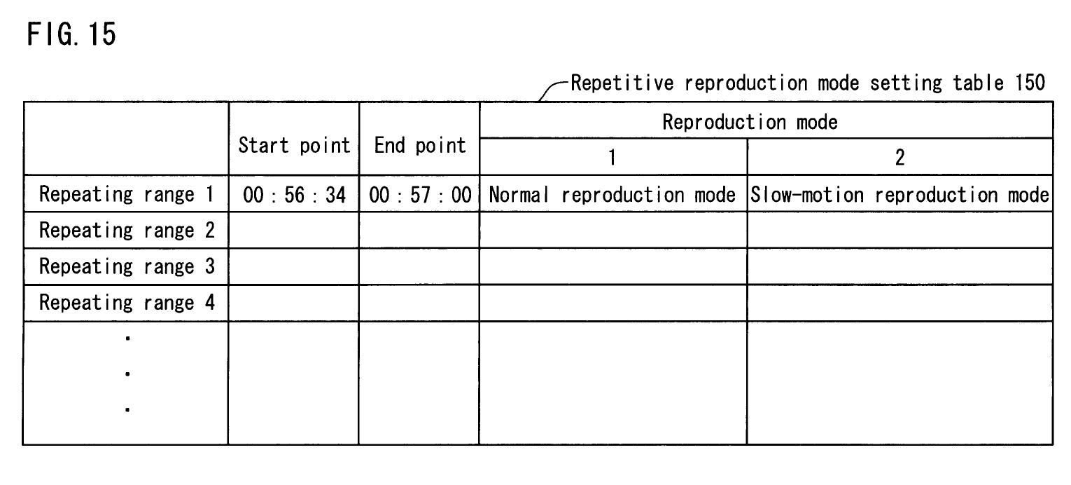

The DVD reproducing device in the third embodiment specifies a single reproduction mode for each repeating range. A plurality of reproduction modes may be specified respectively for a plurality of reproducing cycles of the reproducing procedure for each repeating range. For example, a repetitive reproduction mode setting table 150 as shown in FIG. 15 may be stored in the storage device 16 to specify different reproduction modes for reproducing cycles of a reproducing procedure for each repeating range. When the repetitive reproduction mode setting table 150 is used, a reproducing process including a normal reproduction mode reproducing procedure for the repeating range 1, a normal reproduction mode reproducing procedure for the repeating range 2, a slow-motion reproduction mode reproducing procedure for the repeating range 1, a quick forward reproduction mode reproducing procedure for the repeating range 2, . . . or a reproducing process including a normal reproduction mode reproducing procedure for the repeating range 1, a slow-motion reproduction mode reproducing procedure for the repeating range 1, a normal reproduction mode reproducing procedure for the repeating range 2, a quick forward reproduction mode reproducing procedure for the repeating range 2, . . . can be achieved. The repetitive reproduction mode setting table 150 is also an individual repetitive reproduction mode setting table.

Although the foregoing embodiments have been described on an assumption that the information recording medium is the DVD, the information recording medium may be, for example, a HDD, a VCD, a DVA, a CD or the like. The information recording medium may be a semiconductor storage device. The DVD device of the present invention is not limited to the generally called DVD player and may be any device capable of reproducing data from an information recording medium storing video contents and having additional functions, such as a DVD recorder capable of recording information, a television set with a built-in HDD, a video camera, a digital camera, a personal computer or the like.

Although the invention has been described in its preferred embodiments with a certain degree of particularity, obviously many changes and variations are possible therein. It is therefore to be understood that the present invention may be practiced otherwise than as specifically described herein without departing from the scope and sprit thereof.

What is claimed is:

1. A reproducing device having a repetitive reproduction function capable of repetitively reproducing a reproducing range and of carrying out a reproducing procedure for reproducing a single or a plurality of sets of contents recorded on an information recording medium, said reproducing device comprising:
a storage device storing a repeating range defined by a repetition start point and a repetition end point;
a reproducing unit; and
a control unit
wherein, when a special reproduction mode request is made during the execution of the repetitive reproduction function, the reproducing procedure is executed in special reproduction modes specified by the special reproduction mode request while the reproducing procedure for repetitively reproducing contents in the repeating range is continued.

2. A reproducing device having a repetitive reproduction function capable of repetitively reproducing contents in a repeating range and of carrying out a reproducing procedure for reproducing a single or a plurality of sets of contents recorded on an information recording medium, said reproducing device comprising:
a storage device storing a repeating range defined by a repetition start point and a repetition end point;
a reproducing unit; and
a control unit;
wherein:
the storage device stores a repetitive reproduction mode setting table containing, in combination, predetermined reproduction modes in which reproducing procedures are to be carried out during the execution of the repetitive reproduction function and information about the number of repetitions, and
reproducing procedures are executed in the predetermined reproduction modes contained in the repetitive reproduction mode setting table by a number of reproducing cycles corresponding to the number of repetitions during the execution of the repetitive reproduction function.

3. A reproducing device having a repetitive reproduction function capable of repetitively reproducing contents in a repeating range and of carrying out a reproducing procedure for reproducing a single or a plurality of sets of contents recorded on an information recording medium, said reproducing device comprising:
a storage device storing a repeating range defined by a repetition start point and a repetition end point;
a reproducing unit; and
a control unit;
wherein:
a plurality of repeating ranges are stored in the storage device, a repetitive reproduction process for repeating a reproducing cycle for sequentially reproducing the plurality of repeating ranges is executed, an individual repetitive reproduction mode setting table containing, in combination, the plurality of repeating ranges and reproduction modes is stored in the storage device, and a reproducing process conforming to the individual repetitive reproduction mode setting table is executed for the repeating range to be reproduced during the execution of the repetitive reproduction function.

4. A repetitive reproduction function control program to be executed by a reproducing device having a repetitive reproduction function, capable of repetitively reproducing one set or a plurality of sets of contents recorded in an information recording medium, and including a storage device storing a repeating range defined by a repetition start point and a repetition end point, a reproducing unit, and a control unit, the storage device storing a repetitive reproduction mode setting table containing, in combination, predetermined repetitive reproduction modes to be carried out during the execution of the repetitive reproduction function and information about the number of repetitions, said repetitive reproduction function control program comprising the steps of:
obtaining a reproduction mode combined with the information about the number of repetitions from the repetitive reproduction mode setting table when a request for execution of the repetitive reproduction function is made; and
reproducing the repeating range by the number of repetitions for the execution of the repetitive reproduction function in the reproduction mode obtained from the repetitive reproduction mode setting table.

5. A repetitive reproduction function control program to be executed by a reproducing device having a repetitive reproduction function, capable of repetitively reproducing one set or a plurality of sets of contents recorded in an information recording medium, and including a storage device storing repeating ranges each defined by a repetition start point and a repetition end point and an individual repetitive reproduction mode setting table containing, in combination, the plurality of repeating ranges and reproduction modes, a reproducing unit and a control unit; said repetitive reproduction function control program comprising the steps of:
obtaining a reproduction mode combined with the repeating range from the individual repetitive reproduction mode setting table when a request for execution of the repetitive reproduction function is made; and
repeating a process for sequentially repeating the repeating ranges in the reproduction modes obtained from the individual repetitive reproduction mode setting table.
